(19) United States
(12) Patent Application Publication
(10) Pub. No.: US 2020/0352384 A1
(43) Pub. Date: Nov. 12, 2020

(54) PRESSURE COOKER WITH GRILL POT FUNCTIONS

(71) Applicant: Zhongshan Jinguang Household Appliances Manufacture Co., Ltd, GuangDong (CN)

(72) Inventor: Huang Houjun, GuangDong (CN)

(73) Assignee: Zhongshan Jinguang Household Appliances Manufacture Co., Ltd, GuangDong (CN)

(21) Appl. No.: 16/405,690

(22) Filed: May 7, 2019

(51) Int. Cl. A47J 27/08; A47J 27/00; A47J 27/082

(52) U.S. Cl. CPC A47J 27/0817; A47J 27/082; A47J 27/004

(57) ABSTRACT

A pressure cooker with grill pot functions includes a pressure cooker body. The pressure cooker pot body is hinged to a grill pot lid. A heating tube is on top of the said grill pot lid and a lid motor is installed on grill pot lid downwards with a rotating shaft is on top of the heating tube. The lid motor is connected to downward air supply fan blades with a rotating shaft. The inside of the pressure cooker body includes a detachable electric grill.

### TECHNICAL FIELD

The present invention involves a pressure cooker with grill pot functions.

### BACKGROUND TECHNOLOGY

Existing pressure cookers only have one function and can only be used as pressure cookers. Users need to purchase an air fryer to healthily fry food using an air fryer, but families today have narrow kitchens and are unable to store too many cooking equipment. At the same time, the air fryer is an equipment that is rarely used by families. It takes up space and the low utilization rate causes wastage.

### CONTENT OF THE INVENTION

The present invention overcomes the inadequacies of the said technology and provides a pressure cooker with grill pot functions. On the basis of the pressure cooker, the pressure cooker body is combined with a grill pot lid that is installed with a heating tube, allowing the pressure cooker body to function as a grill pot to grill food, achieving the function of multiple uses in one pot, as a pressure cooker and as a grill pot.

In order to achieve the aforementioned purposes, the present invention uses the following technical solution:

The beneficial effects of the present invention are:

The present invention installs a heating tube and downward air supply fan blades in the inner grill pot lid, which are combined with the pressure cooker body to achieve the grill pot function of air grilling and frying; the outer grill pot lid has upward air supply cooling fan blades to cool the outer grill pot lid and prevent it from burning hands and causing a hazard; the inner pot of the pressure cooker body has a detachable electric grill, achieving the function of two uses, as a pressure cooker and as a grill pot; when it is used as a grill pot, while fries are being fried in the pot, the user can grill chicken on the electric grill and prepare many types of food at the same time, which makes it convenient and saves effort.

### DESCRIPTIONS OF DRAWINGS

FIG. 1 is the schematic diagram of the grill pot of the present utility model;

FIG. 2 is the exploded view drawing of the grill pot of the present utility model;

FIG. 3 is the schematic diagram of the pressure cooker body of the present utility model;

FIG. 4 is the schematic diagram of the inner pot of the pressure cooker body of the present utility model;

FIG. 5 is the exploded view drawing of the grill pot lid of the present utility model;

FIG. 6 is the schematic diagram of the pressure cooker of the present utility model.

### SPECIFIC EMBODIMENT METHODS

The embodiments of the present invention will be further described in detail below together with the drawings:

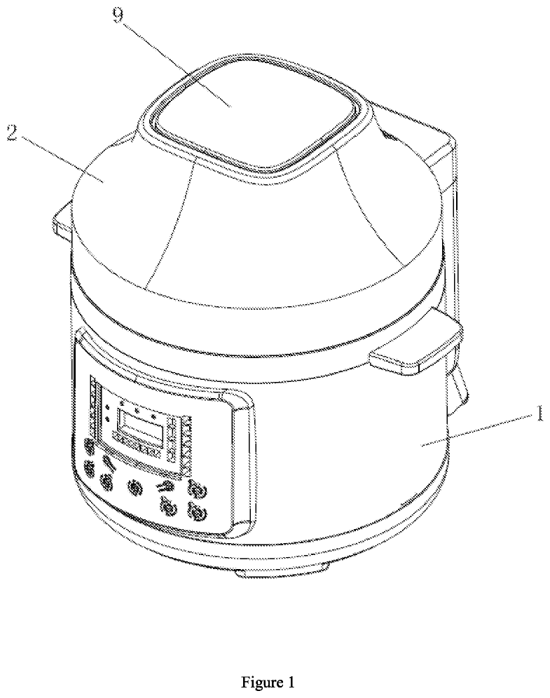

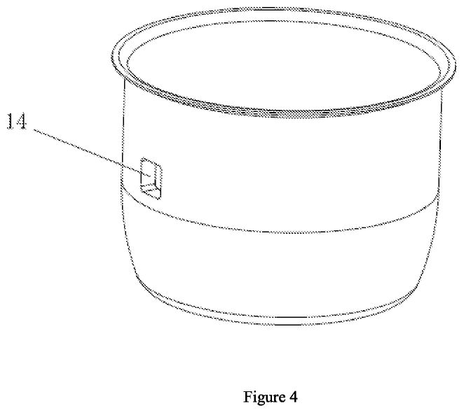

As shown in FIGS. 1-5, a pressure cooker with grill pot functions includes pressure cooker body 1. The said pressure cooker pot body 1 is hinged to grill pot lid 2. Heating tube 3 is on top of the said grill pot lid 2 and lid motor 4 that is installed on grill pot lid 2 downwards with a rotating shaft is on top of the said heating tube 3. The said lid motor 4 is connected to downward air supply fan blades 5 with a rotating shaft. The inside of the said pressure cooker body 1 has a detachable electric grill 6.

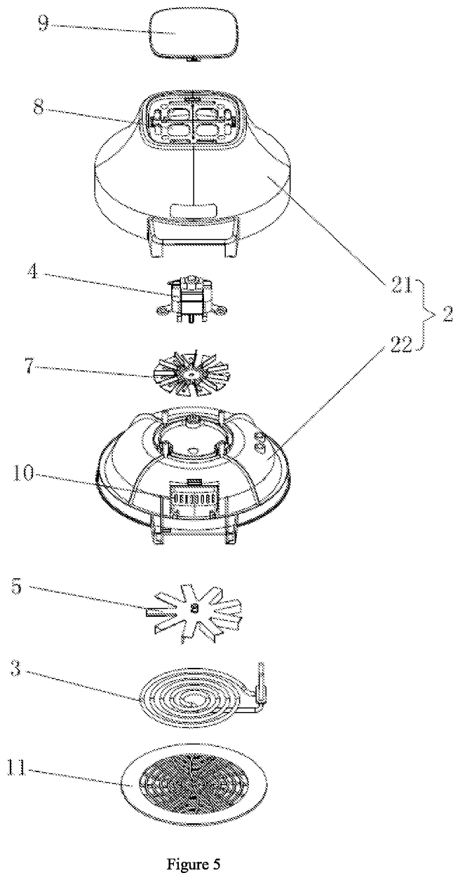

As shown in FIG. 5, the said grill pot lid 2 includes outer grill pot lid 21 and inner grill pot lid 22. The said heating tube 3 and downward air supply fan blades 5 are respectively installed in inner grill pot lid 22. The said lid motor 4 is installed in outer grill pot lid 21. The said lid motor 4 is connected to downward air supply fan blades 5 by rotating through inner grill pot lid 22.

The working principles are as follows:

When it is operated as a grill pot, electric grill 6 may be installed in the inner pot of pressure cooker body 1. The user can place food directly into the inner pot of pressure cooker body 1 and can also place food to be grilled on electric grill 6 and turn it on after putting on grill pot lid 2. At this time, heating tube 3 on grill pot lid 2 will start heating, lid motor 4 will drive downward air supply fan blades 5 to rotate and blow the hot air downwards to the inner pot to grill the food in the inner pot. At the same time, electric grill 6 will rotate and grill the food, achieving balanced degree of cooking. After grilling, open pot lid 2.

As shown in FIG. 5, upward air supply cooling fan blades 7 that are connected to lid motor 4 with a rotating shaft are inside the said outer grill pot lid 21. The top of the said grill pot lid 21 has cooling holes 8 and the said cooling holes 8 have a protective lid 9 that is connected to outer grill pot lid 21. When it is operated as a grill pot, lid motor 4 drives upward air supply cooling fan blades 7 to rotate and cool outer grill pot lid 21 through cooling holes 8.

The top of the said outer grill pot lid 21 has ventilation holes 10 that are connected to inner grill pot lid 22 to increase air flow of the inner pot. The said inner grill pot lid 22 is connected to protective mesh 11 that protects heating tube 3 and downward air supply fan blades 5, preventing direct contact with heating tube 3 and resulting in a hazard.

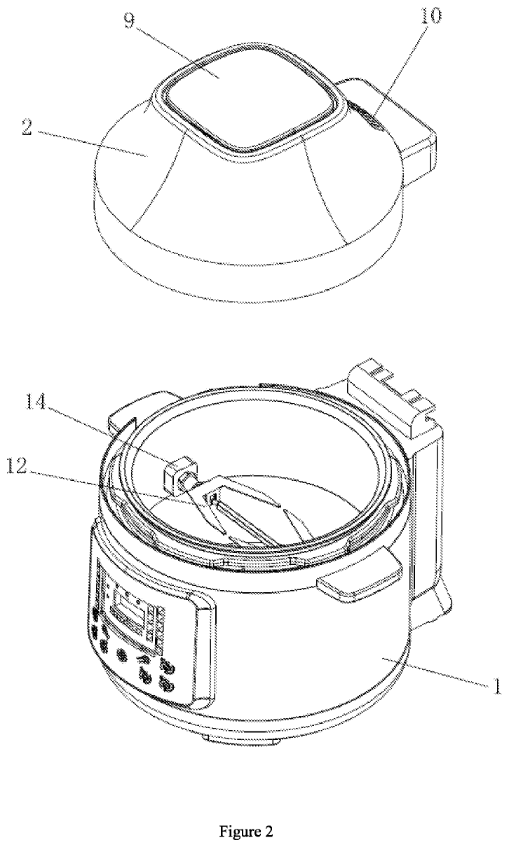

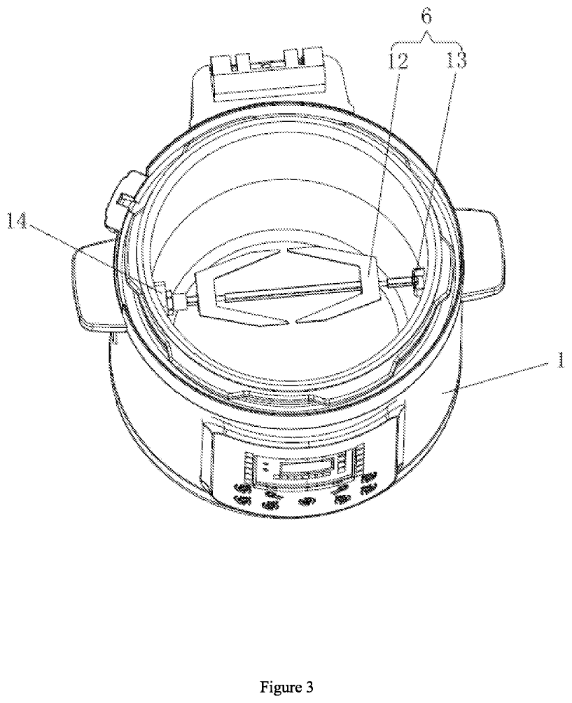

As shown in FIGS. 2 and 3, the said electric grill 6 includes a grill rotating motor installed on the side of the outer pot of pressure cooker body 1. The said grill rotating motor extends into the inner pot of pressure cooker body 1 and the said grill rotating motor is connected to grill 12 with a rotating shaft. The side of the said pressure cooker body 1 has a grill connector 13 that is connected to the other end of grill 12 to facilitate the detaching of electric grill 6. The outer side of the inner pot of the said pressure cooker body 1 has a motor recess 14 that is latched to the grill rotating motor. Recess 14 achieves the effect of fixing the position of the inner pot.

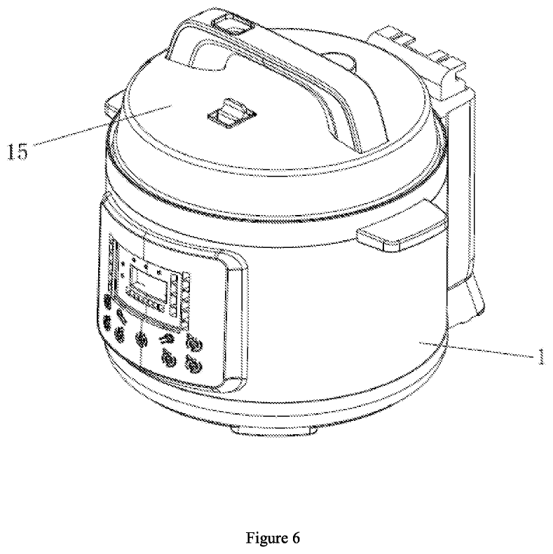

As shown in FIG. 6, the said pressure cooker body 1 can also be connected to pressure cooker lid 15. When it is used as a pressure cooker, detach electric grill 5 from the inner pot and put pressure cooker lid 15 on to achieve pressure cooker cooking functions.

1. A pressure cooker with grill pot functions, wherein: It includes pressure cooker body (1). The said pressure cooker pot body (1) is hinged to grill pot lid (2). Heating tube (3) is on top of the said grill pot lid (2) and lid motor (4) that is installed on grill pot lid (2) downwards with a rotating shaft is on top of the said heating tube (3). The said lid motor (4) is connected to downward air supply fan blades (5) with a rotating shaft. The inside of the said pressure cooker body (1) has a detachable electric grill (6).

2. A pressure cooker with grill pot functions as claimed in claim 1, wherein: The said grill pot lid (2) includes outer grill pot lid (21) and inner grill pot lid (22). The said heating tube (3) and downward air supply fan blades (5) are respectively installed in inner grill pot lid (22). The said lid motor (4) is installed in outer grill pot lid (21). The said lid motor (4) is connected to downward air supply fan blade (5) by rotating through inner grill pot lid (22).

3. A pressure cooker with grill pot functions as claimed in claim 2, wherein: Upward air supply cooling fan blades (7) that are connected to lid motor (4) with a rotating shaft are inside the said outer grill pot lid (4). The top of the said grill pot lid (21) has cooling holes (8) and the said cooling holes (8) have a protective lid (9) that is connected to outer grill pot lid (21).

4. A pressure cooker with grill pot functions as claimed in claim 2, wherein: The top of the said outer grill pot lid (21) has ventilation holes (10) that are connected to inner grill pot lid (22).

5. A pressure cooker with grill pot functions as claimed in claim 2, wherein: The said inner grill pot lid (22) is connected to protective mesh (11) that protects heating tube (3) and downward air supply fan blades (5).

6. A pressure cooker with grill pot functions as claimed in claim 1, wherein: The said electric grill (6) includes a grill rotating motor installed on the side of the outer pot of pressure cooker body (1). The said grill rotating motor extends into the inner pot of pressure cooker body (1) and the said grill rotating motor is connected to grill (12) with a rotating shaft. The side of the said pressure cooker body (1) is installed with grill connector (13) that is connected to the other end of grill (12).

7. A pressure cooker with grill pot functions as claimed in claim 6, wherein: The outer side of the inner pot of the said pressure cooker body (1) has a motor recess (14) that is latched to the grill rotating motor.

8. A pressure cooker with grill pot functions as claimed in claim 7, wherein: The said pressure cooker body (1) is also connected to pressure cooker lid (15).
